(19) United States
(12) Patent Application Publication
(10) Pub. No.: US 2003/0151843 A1
(43) Pub. Date: Aug. 14, 2003

(54) Voice correspondence object

(76) Inventors: Raoul Parienti, Nice (FR); Michel Froelicher, Tallenay (FR); Jean Guenot, Besancon (FR); Bernard Rognon, Besancon (FR)

Correspondence Address: James C Lydon, Suite 100, 100 Daingerfield Road, Alexandria, VA, 22314, US

(21) Appl. No.: 10/257,567

(22) PCT Filed: Apr. 13, 2001
(86) PCT No.: PCT/FR01/01156

(30) Foreign Application Priority Data
Apr. 13, 2000 (FR) 00/04769

(51) Int. Cl. G11B 15/48

(52) U.S. Cl. 360/74.2

(57) ABSTRACT

A voice correspondence object featuring a sound recording medium such as a magnetic tape (2), a playback/recording head (3), an electronic device (21, 25) connected to the playback/recording head for recording sound on the recording medium, a speaker (24), a driving mechanism (4, 5, 6) for the magnetic tape and a spring (7) for moving the driving mechanism when it has been wound, and a current generator (18) powering the electronic device and driving means (5, 6) for the generator driven by the spring when the latter is wound.

### TECHNICAL FIELD

This invention concerns a vocal correspondence object of the type made up of a post card equipped with a device for recording and playing back the sound built into a box adapted to the card.

### BACKGROUND ART

An object of this type is particularly known from European patent application EP 0207258. This object features a magnetic tape, a playback/recording head coupled to an electronic device capable of recording and playing back sound as well as a motorized drive mechanism and an electrical source for providing electrical power to the assembly.

The magnetic tape is wound onto a tape transport wheel which is driven by a mechanical system actuated by an electric motor or by a spiral spring or barrel. The latter's spring is secured inside a driving drum and is wound by a winder or any other rearming device. A playback/recording head in contact with the magnetic tape allows sound to be recorded and played back. Electrical energy is supplied via a battery encased in the card.

With this device, the person sending the postcard can send a personalized voice message to his/her recipient who may listen to the message as many times as desired.

However, as electrical energy is consumed each time the message is played, and the battery progressively discharges each time the message is played, the device rapidly becomes non-functional unless the battery is replaced which requires that the battery be removed from its capsule, which may result in the card being damaged. Also, listening to the card again after several months of non-use is generally not possible as the battery may have lost its capacity in the meantime. Finally, the cards of the type described above resist storage poorly when made using electrolytic batteries as the electrolyte that they contain always ends up leaking out which leads to subsequent damage to the postcard. The use of mercury cells is also not desirable owing to the danger that they represent for the environment. Finally, in certain parts of the world it is often difficult or even impossible to procure batteries which makes it practically impossible to operate the postcard again once the battery is dead.

In order to offset this inconvenience, attempts have already been made to integrate a current generator capable of supplying the electrical power needed, as is the case in U.S. Pat. No. 4,001,887. In this case, however, it is simply a recorder capable of playing back previously recorded sounds by manually turning the crank, the rotation of the crank also causing the electric generator to operate which supplies the power needed by a sound amplifier. It is clear that it is difficult to obtain a constant speed through manual rotation. Even if it were somehow possible to control the rotation while playing back sounds, as in the device described, it would be out of the question to be able to record sound on a magnetic tape while implementing a manually operated mechanism. It would thus not be possible to transpose such an electric generator within the scope of the device described in patent EP 0.207.258. By the same token, it would be difficult to incorporate the lever used in the device of U.S. Pat. No. 4,001,887 into a correspondence object which, by definition, is very thin.

### SUMMARY OF THE INVENTION

This is why the main purpose of the invention is to supply a battery-less correspondence object offering both perfect recording and perfect sound playback capabilities.

The parent idea of the invention consists in using the mechanical energy supplied by a manually-wound spring exclusively to drive both the magnetic tape's drive mechanism and the electrical power generator.

The invention thus concerns a voice correspondence object featuring a sound recording medium such as magnetic tape, a playback/recording head, an electronic device connected to the playback/recording head for recording sound on the recording medium, a speaker, a driving mechanism for the magnetic tape and a spring for moving the driving mechanism when it has been wound, and a current generator to power the electronic device and driving means for the generator driven by the spring when the latter is wound.

The main advantage of using a current generator is that it allows one to listen to the message recorded on the magnetic tape even after several years, which the similar battery-powered devices of previous art cannot do.

### BRIEF DESCRIPTION OF THE DRAWINGS

Other features and advantages of the invention will become more apparent from the following description when taken in conjunction with the accompanying drawings in which:

FIG. 1 represents an implementation example of a vocal correspondence object according to the invention, and

FIGS. 2 and 3 are schematic diagrams representing two embodiments of the circuits required for recording and playing back sound respectively in the vocal correspondence object according to the invention.

### DETAILED DESCRIPTION OF THE INVENTION

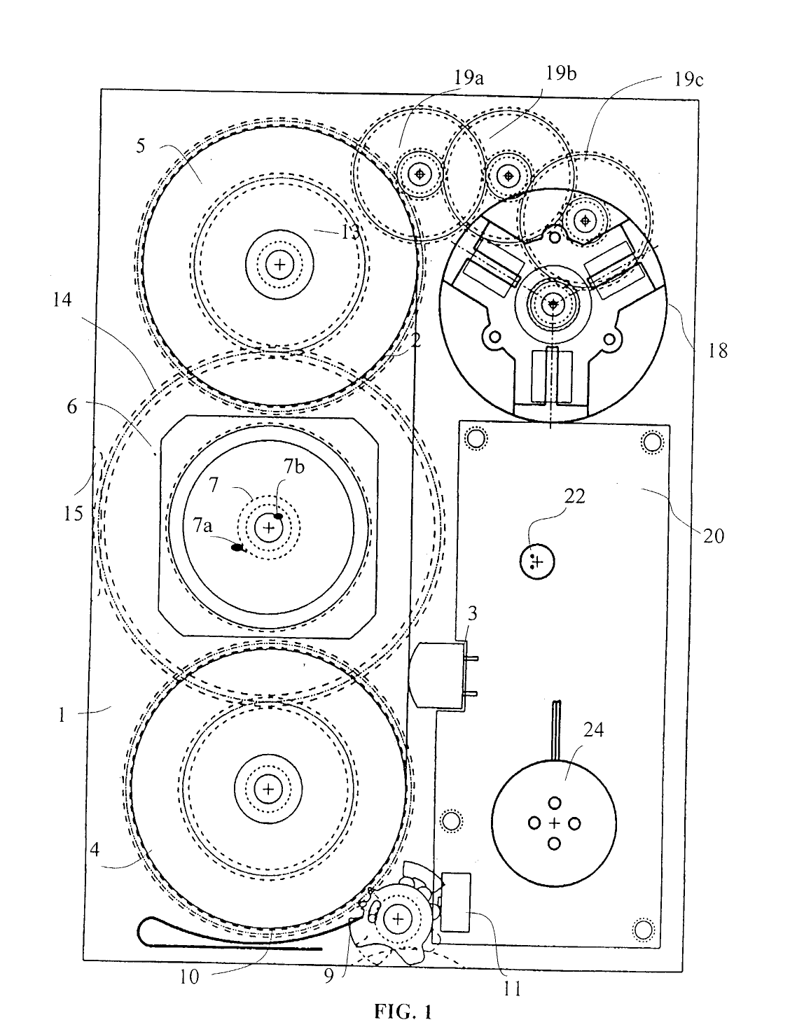

The vocal correspondence object according to the invention, represented in FIG. 1, is particularly designed to be built onto a medium in the form of a postcard but nothing prohibits it from being integrated into medium of various formats.

The vocal correspondence object includes, located inside a housing 1, a magnetic tape 2 passing across a playback/recording head 3 and having each of its ends wound onto two transport wheel, hereinafter referred to as the take-up wheel 4 and the recording/playback wheel 5, respectively. The wheels 4 and 5 are more or less identical in size and are driven simultaneously and in opposite direction by an arming wheel 6. The arming wheel 6 is connected to one end 7a of a spiral spring 7 which is wound around its rotation axis 8. The other end 7b of the spiral spring 7 is secured to the housing 1. The periphery of the take-up wheel 4 is toothed and is prevented from rotating in the direction opposite the rewinding direction by an anti-reverse lever consisting of a ratchet 9 and a spring 10. The spring 10 presses the ratchet 9 between two teeth of the take-up wheel 4 when the spring 7 is wound. The anti-return lever is disengaged by a push-button 11 in order to enable, when the spring 7 has been wound, the arming wheel 6 to rotate as a result of action by the spring 7 and rotation of wheels 4 and 5 causing the magnetic tape 2 to pass over the playback/recording head 3.

The wheels 4 and 5 are coupled to the arming wheel 6 by two reduction gears formed by two toothed wheels 12 and 13 respectively, concentric to wheels 4 and 5 which mesh with the teeth 14 placed around the periphery of the arming wheel 6. The teeth 14 are flush with the outside surface of the housing 1 on one of its sides through a window 15 to enable the spring 7 to be wound and the magnetic tape 2 to be wrapped onto the take-up wheel 4 through manual action on the arming wheel 6. It should be noted that unlike a purely manual drive as is the case U.S. Pat. No. 4,001,887, the inevitably irregular manual energy provided by the user is transformed into potential energy in the spring which releases its energy in a regular and uniform manner as everyone knows.

The recording/playback wheel 5 also includes a set of drive teeth placed around its periphery to drive the rotor of a current generator 18 in rotation via a set of speed increasing gears 19a, 19b, 19c. While in the preferred embodiment the generator is driven in rotation by the recording/playback wheel 5, it goes without saying that the generator may be driven in rotation directly by the arming wheel 6 by means of the speed increasing gears 19a, 19b, 19c which, in this case, would mesh with the arming wheel 6 and not with the recording/playback wheel 5.

All or part of the devices described here may be placed in front of a transparent window (not shown) on the housing to allow the wheels' movements to be seen during recording and playback operations.

According to a preferred embodiment of the invention, the tension from the spring 7 and the gear ratios are designed to rotate the generator 18 continuously for 30 or 40 seconds at approximately 3,000 rpm, and ensure a magnetic tape 2 travel speed of approximately 5 cm/s over a length of approximately 235 cm, which corresponds to approximately 15 rotations of wheels 4 and 5. In order to obtain correct consistency in terms of recording and playback of the magnetic tape (2), a viscous friction torque may be added to the output shaft of the generator 18 by means of a Foucault disk (not shown), for example. The generator 18 supplies the electrical power necessary to supply the sound recording and playback circuits. In the implementation framework of the invention, the generator must be able to deliver approximately 120 mW of power, which may be obtained with a traditional three-phase asynchronous generator, for example. The electronic circuitry required for sound recording and playback is placed on a printed circuit represented by reference 20 in FIG. 1.

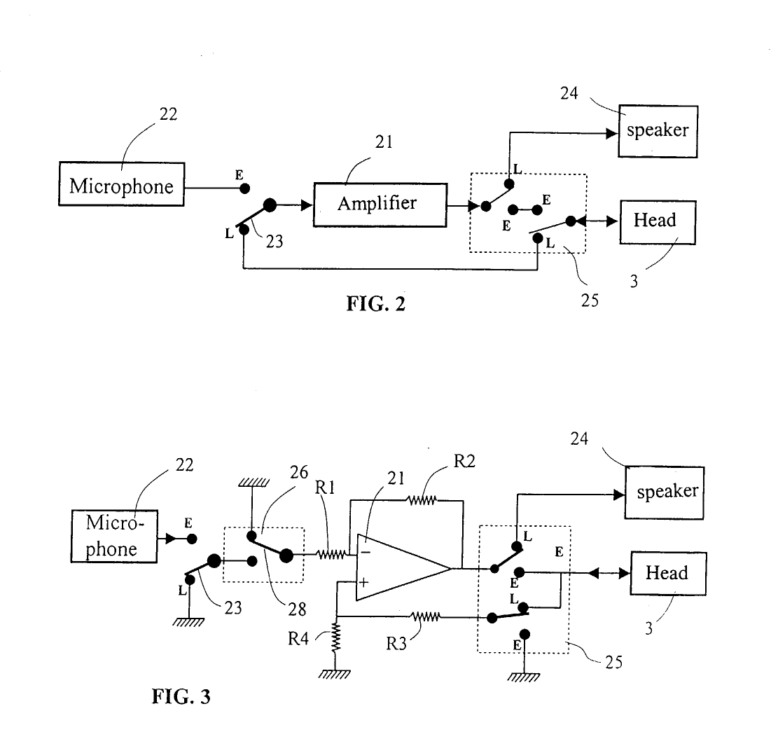

As shown in FIG. 2, the sound recording and playback circuitry essentially includes an amplifier 21 coupled to a microphone input 22 through a two-position switch 23 (“Record R” and “Play P”) and coupled to both a speaker 24 and to the playback/playback recording head 3 on its output through a two-position switch 25 (“Record R” and “Play P”).

While recording, the signal supplied by the microphone 22 is amplified by the amplifier 21 and is applied to the recording head 3 which records it on the magnetic tape 2.

During playback, the signal supplied by the recording head 3 is applied to the input of the amplifier 21 in order to be amplified and retransmitted in the form of sound via the speaker 24. In this embodiment, the switches 23 and 25 may be actuated by a single push-button which is pressed to record and which replaces the assembly in playback mode when released. If necessary, a frequency generator (not shown) may be provided which applies a signal, of frequency greater than that of the sound, to the playback/recording head 3 in order to erase the magnetic tape before a new recording is made.

According to an essential characteristic of the invention, it is possible to prevent all new recordings, as shown in FIG. 3, when an initial recording has been made on the magnetic tape. For this purpose, an end of tape detection device 26 prevents the signal coming from the microphone 22 from being transmitted to the recording/playback head 3 in a permanent manner.

As shown in FIG. 3 where the elements equivalent to those in FIG. 1 bear the same references, the amplifier 21 is installed as a differential amplifier and the end of travel detector 26 is placed in series between the switch 23 and the input marked “-” of the amplifier 21 through a resistor R1. At the end of the magnetic tape, a micro-contact 28 of the detector 26 places the end of the resistor R1 not connected to the input“-” of the amplifier 21 on the earth potential of the circuit in an irreversible manner, resulting in the device being able to function only in playback mode.

The detector 26 may be made by all known methods, either by a cam driven in rotation by a reduction gear assembly coupled to the rewinding wheel 4 and which pushes a retractable micro-contact 28 when the magnetic tape is at its end of travel, or by a magnet driven by a reduction gear assembly which switches a micro-contact 28 to ground when the end of travel is reached. In these embodiments, the reduction gear assembly's speed reducing ratio is calculated so that the cam turns an angle less than 360 degrees while the magnetic tape 2 is moving. If necessary, the detector 26 may be made using electronic means capable of memorizing the status of the magnetic tape's 2 end of travel by means of non-volatile memory, this status thus being signaled when a marker (not shown) carried by the magnetic tape 2, is detected.

According to an implementation variant of the invention, the assembly consisting of the electronic device 21, the magnetic tape 2, and the playback head 3 may be replaced by an electronic micro-circuit such as a chip featuring sound encoding, memory and decoding means. In this case, the electricity generator 18 which supplies said micro-circuit is driven in rotation directly by the arming wheel as described above or via the wheel 5 which thus performs only a drive wheel role. The arming wheel is still driven by a spring similar to that shown in FIG. 1, although the rewinding wheel 4 no longer exists. In this case, the anti-return lever consisting of the ratchet 9 and the spring 10, must be placed on the drive wheel 5.

1. A voice correspondence object featuring a sound recording medium such as a magnetic tape (2), a playback/recording head (3), an electronic device (21, 25) connected to the playback/recording head for recording sound on said recording medium, a speaker (24), a driving mechanism (4, 5, 6) for said magnetic tape and a spring (7) for moving the driving mechanism when it has been wound;
said object being characterized in that it also includes a current generator (18) powering said electronic device and driving means (5, 6) for said generator, said driving means being driven by said spring when the latter is wound.

2. The object according to claim 1, in which said driving mechanism includes a recording/playback wheel (5) for said magnetic tape (2) and a rewinding wheel (4) for said magnetic tape, said wheels being driven in rotation in the same direction under the effort of said spring (7).

3. The object according to claim 2 in which said drive mechanism also includes an arming wheel (6) integral to one end (7a) of said spring (7), said arming wheel being actuated manually by the user to wind said spring so that said arming wheel is driven in rotation through the action of said spring releasing its stored potential energy and drives said recording/playback (5) and rewinding (4) wheels.

4. The object according to claim 3, in which the driving means of said generator (18) primarily includes said arming wheel (6) driving said current generator (18) either directly or via said recording/playback wheel (5).

5. The object according to any one of claims 2 to 4, in which said rewinding wheel (4) is prevented from being driven in rotation in the direction opposite that of rewinding by means of an anti-return lever (9, 10).

6. The object according to claim 5 including a push-button 11 for disengaging the anti-return lever (9, 10) of said rewinding wheel (4) and to control the action of said spring (7) to allow the magnetic tape (2) to move past the playback/recording head (3).

7. The object according to any one of claims 1 to 6, in which said electronic device includes an amplifier (21) coupled between a microphone (22) and a speaker (24) by means of switches (23, 25) actuated by a single push-button enabling, when pressed, to record the signal on the magnetic tape (2) and, when released, to playback the signal recorded on the magnetic tape (2).

8. The object according to any one of claims 1 to 7, further including a device for detecting (26) the end of travel of the magnetic tape (2) which prevents any new recording to be recorded on the magnetic tape (2) in a permanent manner when a first recording has already been made.

9. The object according to claim 8, in which said detection device (26) features a retractable micro-contact actuated by a cam (27) driven by a reduction gear assembly coupled to the rewinding wheel (4).

10. The object according to claim 8, in which said detection device (26) includes a non-volatile memory to record the end of travel status of the magnetic tape (2), this status being signaled by the detection of a marker placed on the magnetic tape (2).

11. The object according to claim 1, in which said sound recording medium and said electronic device are built into an electronic microcircuit such as a chip including sound encoding, memorization and decoding means.
